(19) United States
(12) Patent Application Publication
(10) Pub. No.: US 2010/0013187 A1
(43) Pub. Date: Jan. 21, 2010

(54) Bicycle Utility Bracket

(76) Inventor: Lonnie Rex Oxley, Versailles, KY (US)

Correspondence Address: LONNIE REX OXLEY, 5023 VENETIAN WAY, VERSAILLES, KY, 40383, US

(21) Appl. No.: 12/460,266

(22) Filed: Jul. 16, 2009

Related U.S. Application Data
(60) Provisional application No. 61/135,140, filed on Jul. 17, 2008.

(51) Int. Cl. B60P 3/06; B62J 11/00; B62K 27/00

(52) U.S. Cl. 280/402; 280/202; 280/204

(57) ABSTRACT

A bicycle utility bracket to accommodate an auxiliary child seat and a towed bicycle that can be mounted on either rigid or suspension type bicycle frames. To accommodate a towed bicycle, the bicycle utility bracket device is positioned between a tow bicycle, such as an adult bicycle, and a towed bicycle, such as a child's bicycle, enabling the towed bicycle to function as a one wheeled trailer behind the leading tow bicycle. This or a variation of this same device can also accommodate an auxiliary child seat. The device can include pivoting structure provisions which can articulate with a suspension style bicycle frame as it articulates. This device can also provide a cushioned ride for an occupant in the child seat and a rider on the towed bike when used with a suspension type bicycle. It also includes provisions to quickly and conveniently attach or remove a towed bicycle which allows each bicycle to be operated independently as desired. When the towed bike or child seat is disconnected, the compact bicycle utility bracket device can conveniently remain on the tow bike.

### RELATED APPLICATIONS

This application claims priority to provisional applications Ser. No. 60/961,304 filing date July 2007 and Ser. No. 61/135,140 filing date Jul. 17, 2008, both of which are incorporated by reference in their entireties.

### BACKGROUND OF THE INVENTION

1. Field of Invention

This present invention relates to bicycles with both rigid and suspension type frames. It allows an auxiliary child seat to be secured behind the rider to either rigid or suspension type bicycle frame configurations. On suspension type bicycles, it can improve the comfort for the occupant in the auxiliary child seat since the seat mounting arrangement benefits from the vibration dampening characteristics of the suspension bicycle. Currently, most commercially available rear mounted child seats are only accommodated on rigid style bicycle frames while my invention can accommodate either rigid or suspension style bicycle frames.

This concept also relates to bicycle accessory trailers and towed bike arrangements. This device particularly accommodates towing a conventional bicycle assembly that a passenger can ride upon behind the lead or tow bicycle. When used with suspension type bicycles, the bicycle utility bracket device provides improved riding comfort for the towed bicycle rider since the device transfers the vibration dampening benefits of the tow bicycle to the front of the towed bicycle. Provisions are included to allow the towed bicycle to conveniently be removed and reattached to the tow bicycle allowing the towed bicycle to be operated independently as desired. When the bicycles are separated, the tow bicycle can be operated while the bicycle utility bracket device remains on the tow bike.

The utility bracket can also simultaneously accommodate both the previously mentioned auxiliary child seat and a towed bicycle. It can also accommodate most common sizes of tow bicycles such as 16″, 20″, 24″ and 26″ configurations. The bicycle utility bracket device economically utilizes commonly available bicycle configurations for towing verses the necessity for a dedicated towed bicycle design. It also does not require any permanent modification to the tow or towed bicycle designs.

2. Prior Art

The present invention is an outgrowth of my provisional application, Towing Bike Arrangement, application No. 60/961,304. This included a method to tow a conventional bike in a very stable manner relative to other tow bicycles.

Multiple other tow bike arrangements exist that are dedicated type towed bicycle design. In many cases this means an expensive, dedicated tow bicycle configuration needs to be purchased and consequently stored when not in use such as in George U.S. Pat. No. 5,785,335. Many of these designs such as Adams U.S. Pat. No. 5,470,088 have a long tube connected to the seat post of the main bike and incorporate a “U” joint type coupling arrangement. These multiple mechanical joints between the two bikes can develop wear or can loosen causing the towed bike and rider to wobble or lean. This causes discomfort and anxiety for the towed rider and control difficulties for the tow bike operator. Failure of this articulating connection coupling on some of these type designs have also been the subject of safety recalls. The small bearing areas and focused loading in these articulation joints are not as durable as compared to the wide bearing spacing of a wheel mounted in a front bicycle fork or the bearing provision for the bicycle steering yoke.

Another popular towed bicycle design, Asbury et al. U.S. Pat. No. 6,983,947, accommodates towing small conventional type bicycles but the mounting arrangement to the towed bike head tube tends to come loose and wobble. It can also scratch and deform the towed bicycle frame where the attachment bracket is mounted. This overall design arrangement is also longer since the front wheel is left on the towed bicycle when attached. The towed bike is attached at an inclined angle to achieve ground clearance of the front wheel. This inclined bicycle angle can cause the towed rider to be in an uncomfortable position. Additionally, this previously mentioned front tire ground clearance can be insufficient when crossing curbs or large holes resulting in a dangerous control problem. A similar design is also described explained in Bourbeau U.S. Pat. No. 6,155,582

The high articulation attachment points between these tandem style bicycles are typically near the tow bicycle seat post and can result in a forward tipping condition of the tow bike during hard braking. Particularly, braking force from the tow bicycle's front wheel brake and the resulting inertia force from the tow bicycle & operator and the decelerating tow bike which is applied high at the seat post can cause the tow bike's rear wheel to lift and result in an accident.

Several other tow bicycle designs either modify the tow bicycle, such as Carswell U.S. Pat. No. 1,300,343, or modify the towed bicycle, such as Strong U.S. Pat. No. 4,458,908 or Lin U.S. Pat. No. 6,290,246 in order to accommodate a tandem towed bicycle arrangement

Most bicycle auxiliary child seats consist of a support bracket system that rigidly mounts to a rigid type bicycle frame. Until now, there has been no commercially available child seat that can accommodate the relative motion between the seat post and the rear section of the suspension type bicycle frame. If someone attempts to install one of these conventional child seats on a suspension style bicycle, the main bicycle suspension system could not properly articulate and the child seat support brackets would result in a binding situation preventing relative motion between the pivoting front and rear frame sections of the main bicycle and damage to the child seat support structure. Suspension bikes can also vary significantly from each other with regard to frame configurations making a universal child seat fit a challenge.

Additionally, most towed bicycle designs can not accommodate the simultaneous use of an auxiliary child seat since the tube which typically connects the tow bicycle to the towed bicycle would interfere with the auxiliary child seat. Couture U.S. Pat. No. 5,842,710 has both a connection tube and a horizontal front wheel storage provision that would interfere with a rear mounted auxiliary child seat. This design also does not accommodate yaw articulation between the tow and towed bicycle which would result in control problems.

A different stored front tire design is shown in Bartoshesky U.S. Pat. No. 5,860,662. This requires a separate tire mounting bracket and it hampers pedal operation clearance for the towed bicycle operator. It is also difficult to achieve a secure wheel mounting with this design since it is fastened at the outside perimeter of the stored tire against flexible rubber.

A suspension type frame tow bicycle with a custom towed bicycle design is described in Humes U.S. Pat. No. 6,796,572. It does not accommodate vibration dampening in the vertical direction for the towed bicycle. This design can also transfer horizontal shock loads into the towed bicycle caused by articulation of the suspension bicycle frame through the connecting linkages between this tandem bicycle configuration. In other words, the ride vibration dampening characteristics of the tow bicycle do not improve the ride of this towed unit configuration.

### SUMMARY OF THE INVENTION

My bicycle utility bracket device accommodates an economical conventional bicycle that can be utilized as a towed bicycle unit behind a tow bike. This towed bicycle can conveniently be attached or removed for independent operation of both bicycles as desired. The vertical yaw and horizontal pitch articulation connections between the towed and tow bicycles utilize economical, durable, wide spaced bearing designs that are already used and proven on conventional style bikes resulting in a safe, steady ride for operators on both the tow and towed bicycles. It also accommodates an auxiliary child seat on a suspension type bicycle. Stand-alone auxiliary child seat mounting design variations of the concept that do not accommodate towed bicycles can also be made economically. The same child seat supporting device can be made to accommodate either rigid or suspension type bicycle configurations. When mounted on suspension type bicycle frames, the device can accommodate a cushioned the ride for both the operator of the tow bike and the passenger in the child seat. This is accomplished without permanent modifications to the tow/main bike and can be made to accommodate a universal fit on multiple different bicycle designs.

### OBJECTIVES OF THE INVENTION

A rear mounted auxiliary child seat support structure device compatible with suspension style bicycle configurations. The same device can also be used on rigid frame bikes.

A child seat support structure linkage that can be oriented to accommodate near vertical relative motion between the child seat and suspension type bicycle frame structure when the suspension bicycle articulates.

A bracket design that can simultaneously accommodate a tow bike and/or an auxiliary child seat on both rigid frame and suspension frame type bicycles.

A bicycle utility bracket design which fits on conventional rigid or suspension frame style bicycles that is also connected to a conventional style bicycle to serve as a towed bicycle which eliminates the need to purchase and store a custom, dedicated towed bicycle design.

The ability to disconnect the towed bike from the tow bicycle and allows both bicycles to be operated independently. The bicycles can be quickly reattached as desired for faster, safer distance travel or to give the child a ride when child's stamina is waning. When connected, the towed bicycle can also be pedaled by the towed bicycle rider to assist in propelling the bicycles when connected.

This bicycle utility bracket device can include a provision to store the towed bicycle front wheel in a vertical orientation, which means the wheel's axle shaft is horizontal, on the bicycle utility bracket with the center axle of the stored wheel positioned forward of the towed bike's conventional front wheel axle mounting provision and behind the axle of the tow bicycle. This storage orientation does not interfere with pedaling of either bike. This vertically stored front tire location can also be made to accommodate clearance for an auxiliary child seat.

A bicycle utility bracket device that accommodates commonly available 16″, 20″, 24″ & 26″ bicycles for towing. The adjustment provisions of this bicycle utility bracket system allow the various towed bike sizes to be attached in a relatively level configuration that is comfortable for the towed bicycle operator.

A towed bicycle pitch articulation connection to the tow bicycle that is low to reduce the chance of tipping during hard braking. The articulating pitch connection between the two bicycles is located lower than the centerline of the rear axle of the tow bicycle which results in better stability and control during hard braking as compared to other tandem tow bike configurations. This articulating pitch provision is connected to the front wheel axle mounting provision of the towed bicycle steering fork. This pitch connection provision utilizes a single, continuous length mounting bolt that is located outside of the perimeter of the rear tire of the tow bike. The economical bearing provisions which accommodate this pivoting bolt are wide spaced to minimize loose fit in the articulating connection. Utilizing the existing towed bicycle steering yoke and bearings in the head tube of the towed bicycle for yaw control accurately accommodates articulation about a relatively vertical yaw axis which is necessary for turning maneuvers. The combination of these durable, economical and functional pitch and yaw bearing provisions result in a steady, safe ride for both the tow and towed bike operators.

An optional fender on the bracket assembly in a close, less than 2″, concentrically or nearly concentrically fixed position over the tow bike's rear wheel to minimize debris and liquid thrown up by the tow bicycle's rear wheel from hitting the towed bicycle passenger eyes and body. This fender is also effective to keep mud and debris off the child when using the child seat configuration. It can also keep mud off the rider when no towed bike or child seat is installed.

A bicycle utility bracket attachment means secured to the rear axle of the tow/main bike that can be adapted to most commercially available bikes. This includes a round rotating pivot provision to accommodate frame articulation associated with suspension type bicycles. It also includes stand off clearance provisions for the chain & chain shifter type mechanism which is common on many bikes. This replaces the conventional rear axle mounting nuts on the lead or tow bicycle. It can also include a keeper hole provision that can be used to secure the bracket to the main bicycle.

A method to flip an empty, towed bike onto the utility bracket structure for bicycle hauling purposes. This accommodates an effective way to keep the bikes connected while eliminating the rolling resistance and bouncing imposed upon the lead bicycle by an empty tow bicycle while traveling. It also allows the overall tandem bicycle length to be shortened which improves mobility in tight places. It gives the lead bicycle rider the option, for example, to ride alone from home with the bike in a ∓flipped up” position to pick up a child from school, reposition the tow bike back on the ground and then both riders can return homeward on their respective bicycles which are either connected to each other or independent.

An accessory carrying rack option that can be mounted to the utility bracket system's upper horizontal connection links. A similar rack design can be incorporated into a rigid type tow bicycle utility bracket design.

A flexible linkage and elastomeric tensioning means between the tow and towed bicycles to prevent the towed bike from falling over when the towed bike orientation approaches a relatively perpendicular orientation to the tow bike. The preferred method includes an economical elastic element, such as a bungee cord, attached to an economical flexible linkage, such as a chain, to prevent any chain slack from entangling with the rear tire of the tow bicycle. An alternative method could include a set of tubes that slide along a common axis relative to each other with a length limiting stop to prevent the towed bicycle from tipping over during sharp turns or during back up maneuvers while still accommodating relative motion between the bicycles. Adequate take-up is required in the above linkage concepts, for example, to allow the rear wheel of the towed bicycle to cross over a bump or curb while the towed bicycle rear tire and the tow bicycle's front tire are still in contact with the ground.

Provisions for secure storage for the front wheel of the towed bike positioned such that it has adequate clearance from other components and accommodates overall functional interface with the tandem bicycle arrangement. For small 16″ style towed bicycles, this can be accommodated via a simple hole in a wheel mounting plate on the utility bracket that minimizes overall width and allows adequate pedal clearance and still accommodates an auxiliary luggage rack or child seat, etc.. Larger towed bikes tires, which normally have a larger diameter front axle thread size, can be accommodated by a threaded type front wheel holding provision that orients this bigger tire in a manner which accommodates stored wheel clearance between both the tow and towed bike.

An auxiliary kick stand to accommodate improved parked stability for the tow and towed bicycle configuration as compared to the level of parked stability offered by conventional bicycle kickstands. This auxiliary kick stand is mounted on the bicycle utility bracket close to the center line of the rear axle of the tow bike to accommodate functional support regardless of the utility bracket adjustment position.

A means to accommodate mounting of a rearward facing safety reflector.

Hand grip type fasteners for mounting the towed bicycle to the utility bracket device to eliminate need for tools when installing or removing the towed bicycle.

### BRIEF DESCRIPTION OF THE DRAWINGS

FIG. 1 Perspective view of the bicycle utility bracket accommodating a tandem bicycle arrangement and auxiliary child seat

FIG. 2 Side view of static tow bicycle, bicycle utility bracket with child seat and towed bicycle mounting and adjustment provisions.

FIG. 3 Side view of articulation motion of suspension type tow bicycle, auxiliary child seat and towed bicycle.

FIG. 4 Exploded view of the bicycle utility bracket and linkage mounting arrangement

FIG. 5A Cross section cuts of the utility bracket linkage system

FIG. 5B Associated cross sections of the utility bracket linkage system in FIG. 5A

FIG. 6A Side view of economy type auxiliary child seat bracket drawing with vertical rear Seat support link

FIG. 6B Side view of economy type auxiliary child seat bracket showing resulting auxilary child seat motion when a suspension frame style bicycle articulates

FIG. 6C Side view of economy type auxiliary child seat with angled rear mounting bracket for auxiliary child seat suspension feature

FIG. 7A Side view of economy type auxiliary child seat support design with alternative rear link seat support attached to the rear suspension bicycle frame section to accommodate a suspension ride for the child seat/occupant

FIG. 7B Auxiliary child seat bracket design from 7A showing relative child seat motion during stroke of a suspension type frame bicycle.

FIG. 8A Tandem configuration of 26″ style tow bicycle and 16″ towed bicycle

FIG. 8B Hauling position for 16″ towed bicycle on a 26″ style tow bicycle via bicycle utility bracket

FIG. 9 Tandem configuration of 26″ style tow bicycle with 26″ type towed bicycle with front wheel in stowed position and associated bicycle utility bracket adjustment

FIG. 10 Tandem configuration of 26″ rigid frame style tow bicycle and 20″ type towed bicycle with front wheel in stowed position and associated bicycle utility bracket adjustment

FIG. 11 Tandem configuration of 26″ rigid frame tow bike and 16″ towed bike with rigid style bicycle utility bracket configuration

FIG. 12 Alternative bicycle utility bracket configuration for rigid frame style tow bicycle

### DESCRIPTION OF THE PREFERRED EMBODIMENT

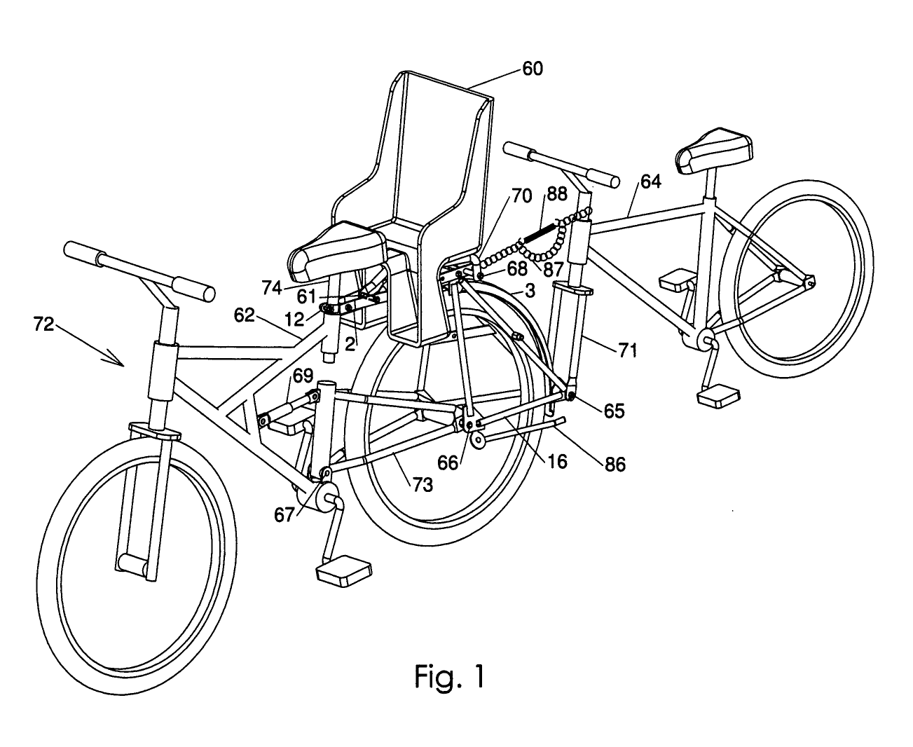

Referring to FIG. 1, a lead tow bicycle 72 with an auxiliary child seat 60 and a towed 20″ type bicycle 64 is shown. The lead tow bicycle 72 is a suspension frame type configuration, however this concept will also work with a rigid frame type bicycle frame assembly. The suspension style bicycle consists of three primary segments. Front frame section 62 is connected to the suspension dampening device 69 and pivots about a pivot axis indicated by 67. The rear frame section 73 also is connected to item 69 and pivots about 67.

The following describes the main components of the invention. A linkage mounting clamp 12 is secured to the seat post 74. It is connected to the two upper links 2 which connect to bicycle utility bracket frame 16. Utility bracket 16 pivots about the rear wheel axle at 66 as the lead tow bicycle frame articulates. Towed bicycle 64 is pivotably connected to utility bracket 16 at pitch connection joint 65 via wheel mounting provisions in the end of front wheel forks 71.

A child's seat 60 is attached to support tubes 70 which in turn connect to the upper links 2 at the mounting bolt centerlines indicated by 61 and 68. An optional fender 3 is attached to utility bracket 16 in addition to optional kickstand 86 that is shown in the up position. An optional connection chain 87 and elastomeric strap 88 is also included between the two bicycles which becomes tight during certain maneuvers preventing the towed bicycle from falling over. This chain 87 connects to utility bracket 16 around the provision which connects to upper links 2. The other end of this chain 87 can be secured to the towed bicycle steer tube or handlebars.

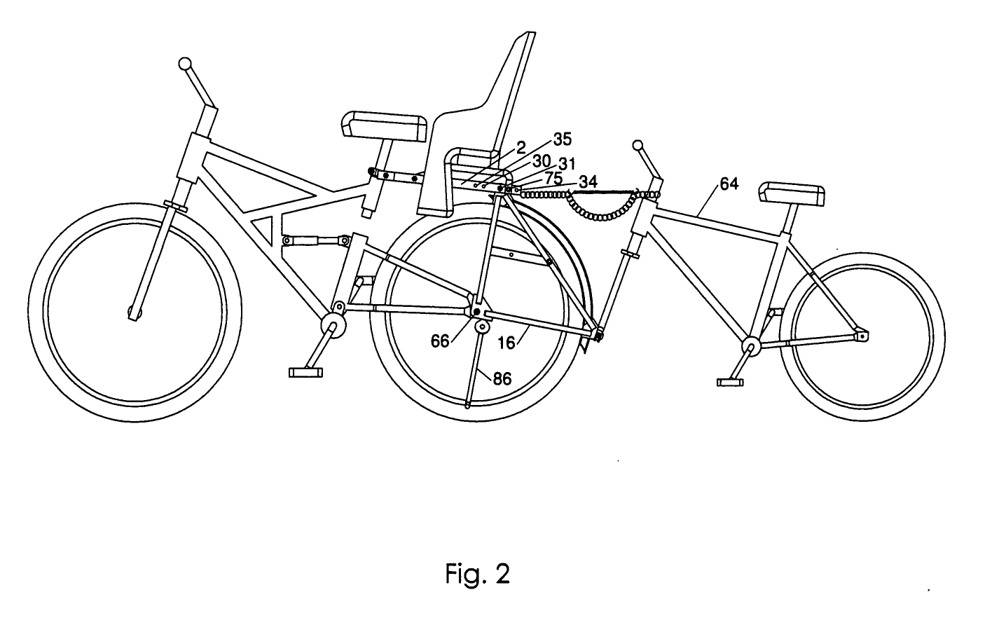

Referring to FIG. 2, this is a side view of the configuration shown in FIG. 1. It also includes callouts for adjustment provisions in upper bracket links 2 to accommodate level towed bicycle fit-up. Hole 35 corresponds with 26″ towed bicycles, hole 30 corresponds with 24″ towed bicycles, hole 31 accommodates 20″ towed bicycles (shown) and hole 34 corresponds with 16″ towed bicycles. The towed bicycle 64 in this illustration is similar to a 20″ type bicycle. The 20″ description corresponds with the bicycle's tire diameter. The utility bracket 16 rotates about the rear wheel axis centerline 66 to accommodate fit-up with upper links 2 at the various mounting positions indicated by holes 35, 30, 31 & 34. The optional kickstand 86 is shown in the down position in this figure. Hole 75 is used to mount the rear of the auxiliary child seat.

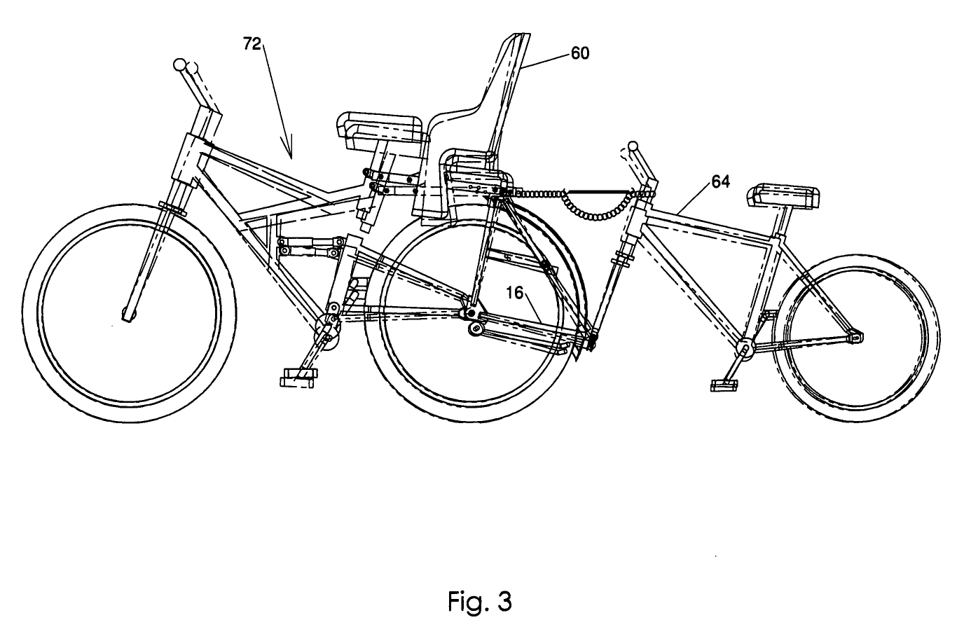

Referring to FIG. 3, this shows an example of the overall tandem bicycle component motion associated with articulation of the suspension tow bicycle frame. This results in a vibration dampening effect on the towed bicycle 64. It also shows the auxiliary child seat 60.

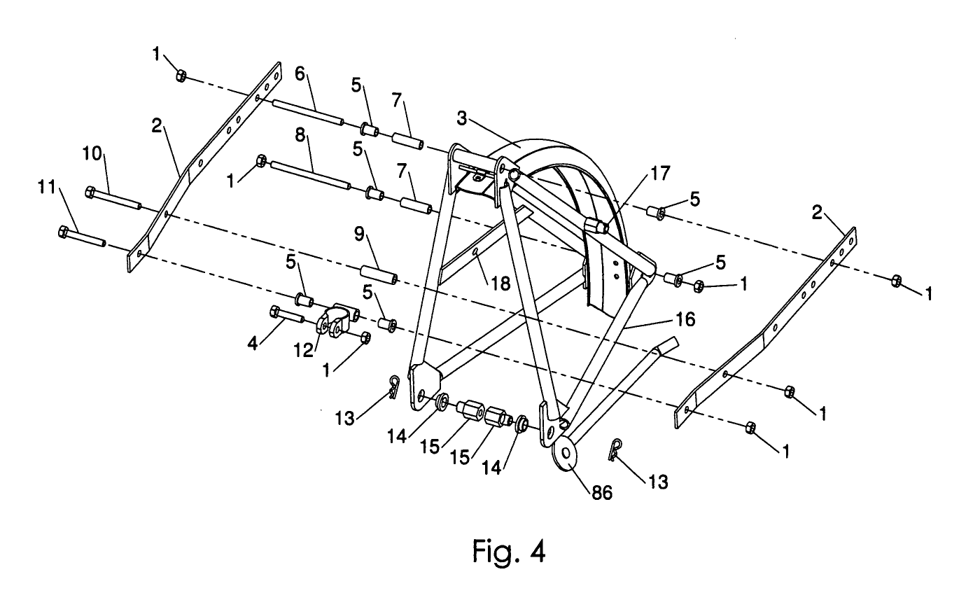

Referring to FIG. 4, this exploded view shows most of the bicycle utility bracket design components that are added to the standard bike 72 from FIG. 1. The utility bracket 16 is pivotably connected to a tow bicycle by replacing the standard rear axle mounting hardware with two pivot nuts 15. These two pivot nuts 15 incorporate threads to match the rear wheel axle and are sized to clear surrounding brackets and miscellaneous hardware commonly installed on most bicycle configurations. A hexagon flat profile is included on pivot nuts 15 to accommodate tightening with a wrench. A round pivot surface on these nuts 15 engage with bushings 14. Bushings 14 are also sized to pivotably engage bracket 16. For this design concept, installation of bracket 16 requires this bracket to be flexed open enough to pass over the ends of the installed pivot nuts 15. Although, multiple other design configurations can be incorporated to achieve the same end result. Once installed, keeper pins 13 are inserted through the keeper hole provision in pivot nuts 15 to secure bracket 16 to the bicycle's rear wheel axis. An optional fender 3 can be mounted to utility bracket 16 to prevent road debris from being thrown up from the rear tow bicycle tire on to the towed bicycle operator or the child in the auxiliary child seat.

A set of upper links 2 are pivotably connected to bushings 5, 11 and nut 1 in clamp 12 which is secured to the bike seat post via bolt 4 and nut 1. The other end of upper links 2 are attached to threaded stud 6, with nuts 1. Stud 6 goes through bushings 5 and spacer 7 which can rotate within the provision provided on utility bracket 16. The towed bike pitch attachment joint consists of threaded stud 8 which goes through a different set of bushings 5 and spacer 7. These parts are pivotably secured into bracket 16 with a first set of nuts 1.

A provision to hold the towed bike front tire for a 16″ style bike is shown at 18. This is located to accommodate clearance for a luggage rack and or auxiliary child seat while adequately clearing the pedal area and ground surface etc. A hole 18 is provided and the wheel is attached by passing the front axle through this hole and securing it with an axle nut on the other side. Another front wheel mounting provision is shown at 17 which includes threads to match the wheel axles commonly used on 20-26″ sized front bicycle wheels. To mount the front wheel, the front axle is screwed into this threaded provision 17. The location of this mounting provision 17 is different than the location of mounting provision 18. The larger diameter of tires associated with 20″-26″ style bikes need to include adequate clearance from the ground, pedal area, auxiliary child seat when possible, etc.

Mounting provisions for the front of the auxiliary child seat are shown via bolt 10, spacer 9, nut 1 and associated mounting hole provisions in upper links 2. An optional kickstand 86 is also illustrated.

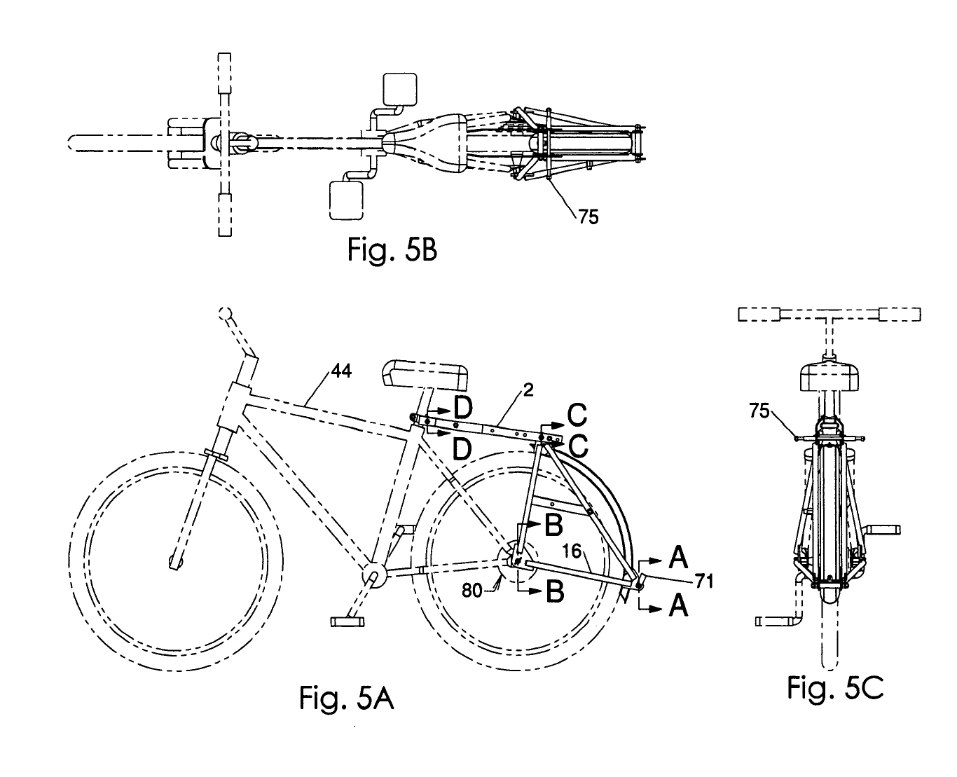

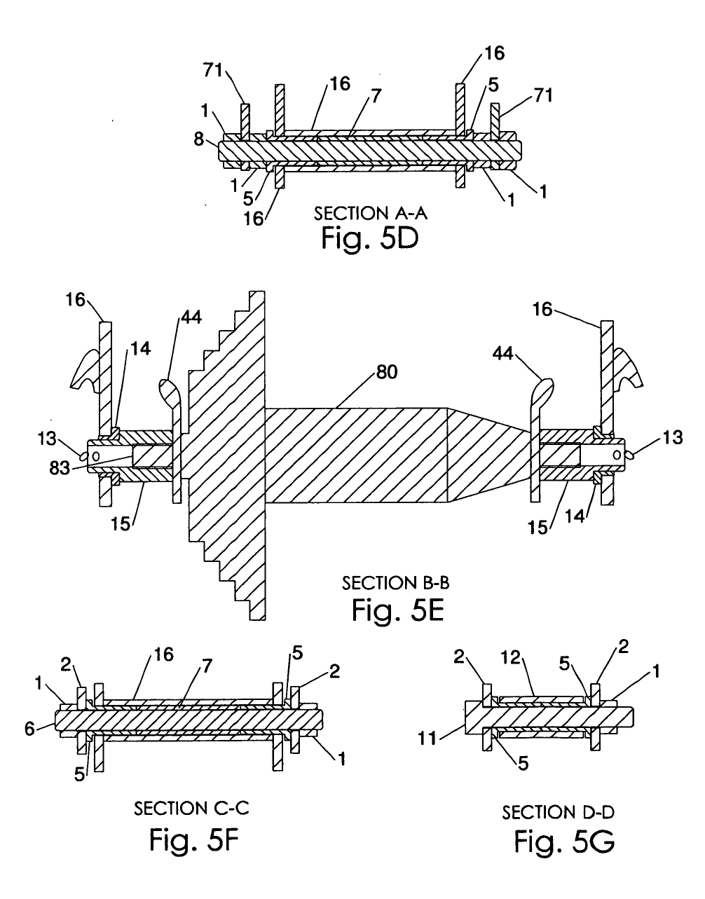

Referring to FIG. 5A, cross section cuts A-A, B-B, C-C and D-D are shown for the utility bracket 16 which in this example is secured to a rigid frame style bike 44. Upper links 2 and a partial front fork segment of the tow bicycle is shown via 71. Top and side views are also shown to clarify the design configuration. An extended length threaded stud 75 is also shown which can be used to attach the rear of the auxiliary child seat support tubes 70 shown in FIG. 1. Nuts and spacers are also shown on this threaded stud 75 to properly secure the rear section of a child seat when installed. The rear wheel assembly section 80 is also identified for clarity in the following FIG. 5B.

Referring to FIG. 5B section A-A, two bushings 5 and spacer 7 are installed over threaded stud 8 and positioned inside utility bracket 16 which pivotably secures these parts in utility bracket 16 with the two inside nuts 1 that are tightened. The front wheel steering forks 71 of the towed bike can be installed over the threaded stud 8 and be secured with two outer nuts 1. Other means of fastening 71 such as a hand operated quick lock cam mechanism in place of outer nuts 1 could be utilized to make this more convenient. Referring to FIG. 5B section B-B, two pivot nuts 15 are installed over threaded bike axle 83 and tightened to rigidly secure the rotating wheel assembly 80 to the bike frame 44. Two rotatable bushings 14 are installed over these pivot nuts 15 and the utility bracket 16 is installed over these bushings. Alternative design methods can be incorporated to minimize the flexing required of bracket 16 to pass over the ends of pivot nuts 15 and make it more convenient to secure, such as a quick locking cam device. In this embodiment, the parts are secured with two keeper pins 13 which pass through a hole provision in pivot nuts 15.

Referring to FIG. 5B section C-C, two bushings 5 and spacer 7 are installed over threaded stud 6 and positioned inside utility bracket 16. Two upper link brackets 2 are installed over threaded rod 6. These parts are pivotably secured in place when the nuts I are tightened.

Referring to FIG. 5B section D-D, two bushings S and the two upper links 2 are installed over bolt 11 and positioned inside seat post clamp 12. Nut 1 is used to tighten these parts together such that they are rotatably secured by pivot clamp 12.

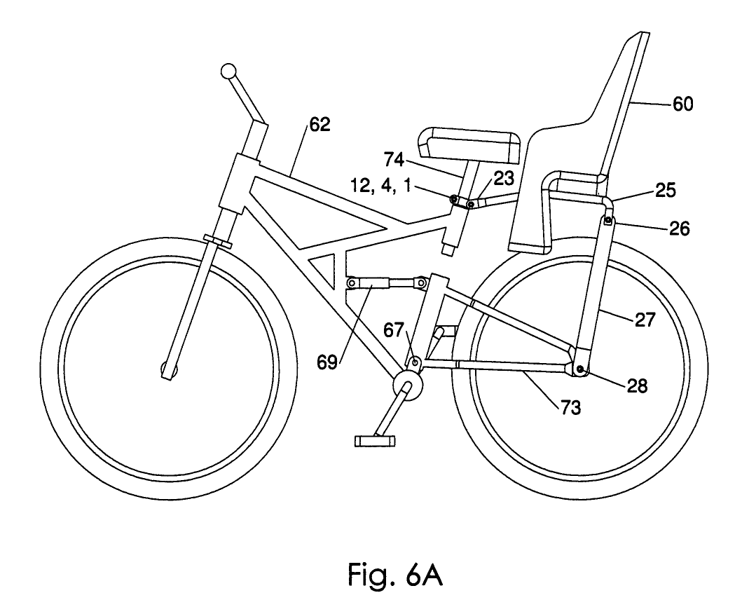

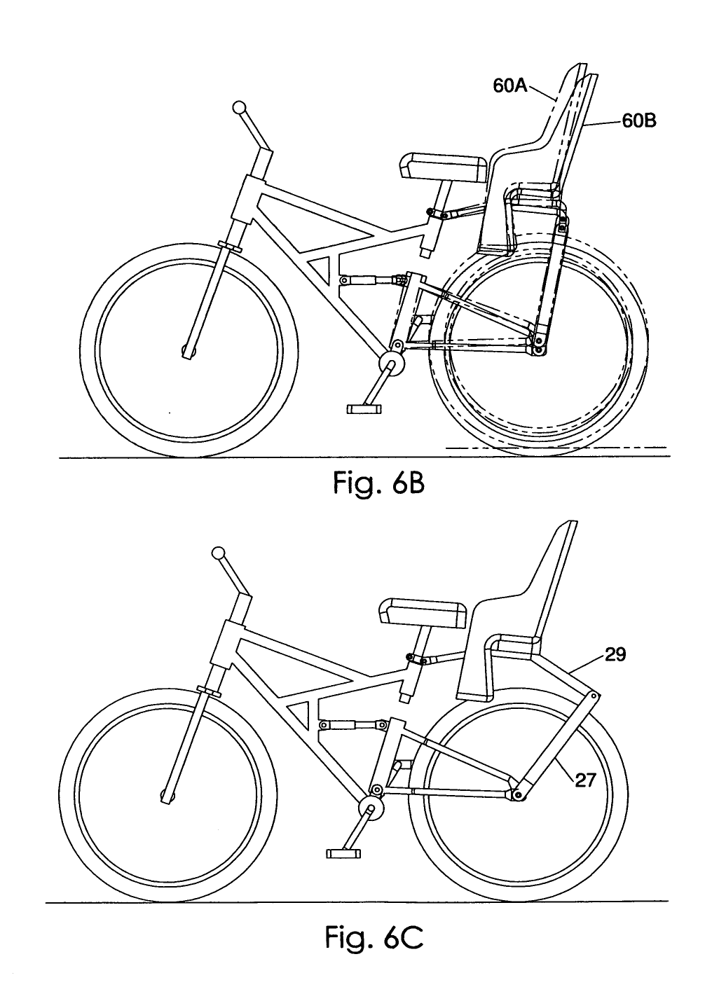

Referring to FIG. 6A, an auxiliary child seat 60 is adapted to a suspension style bike which consists of front frame section 62, a rear frame section 73, a suspension spring/dampener 69 and a frame pivot provision 67. A seat post pivot clamp 12 is attached to the seat post 74 via bolt 4 and nut 1 shown previously. The seat 60 is secured to adaptor tubes 25 which are pivotably secured to the seat post clamp 12 at the tube mounting provisions 23 and at the rear via rear vertical link 27 at mounting provision 26.

The other end of vertical link 27 is pivotably attached to the rear wheel axle 28. In FIG. 6B it shows the relative motion of these parts when the suspension bicycle goes through a suspension stroke. The resulting seat position 60A is when the bicycle frame is loaded or goes over a bump, and seat position 60 B is when it is unloaded. This design offers partial suspension dampening to the auxiliary child seat.

Referring to FIG. 6C an alternative to 6A has angled rear link 27 for improved child seat suspension performance. Rear link 27 is rotated clockwise in this view while seat bracket 29 is an extended version of item 25 in FIG. 6A. This results in the child seat following a similar path to the bike operator's seat, giving the child rider a more cushioned ride.

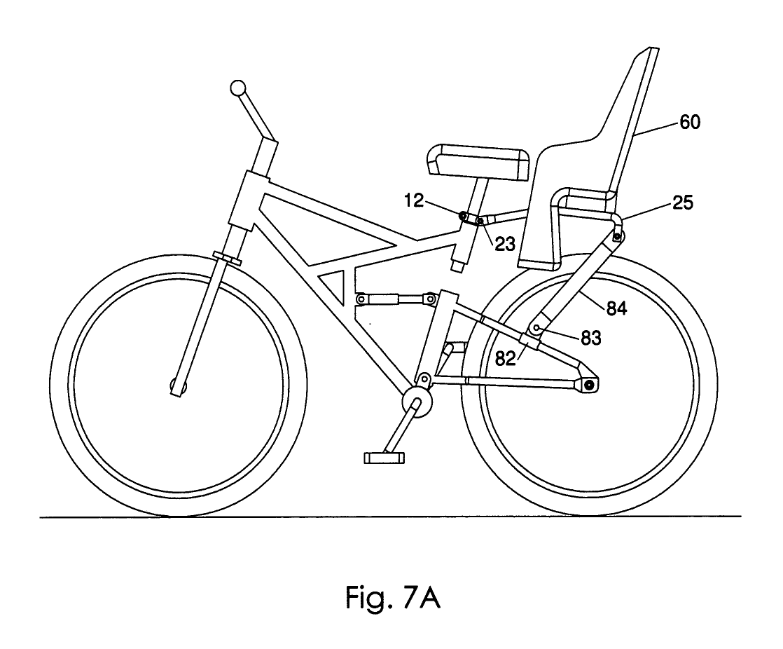

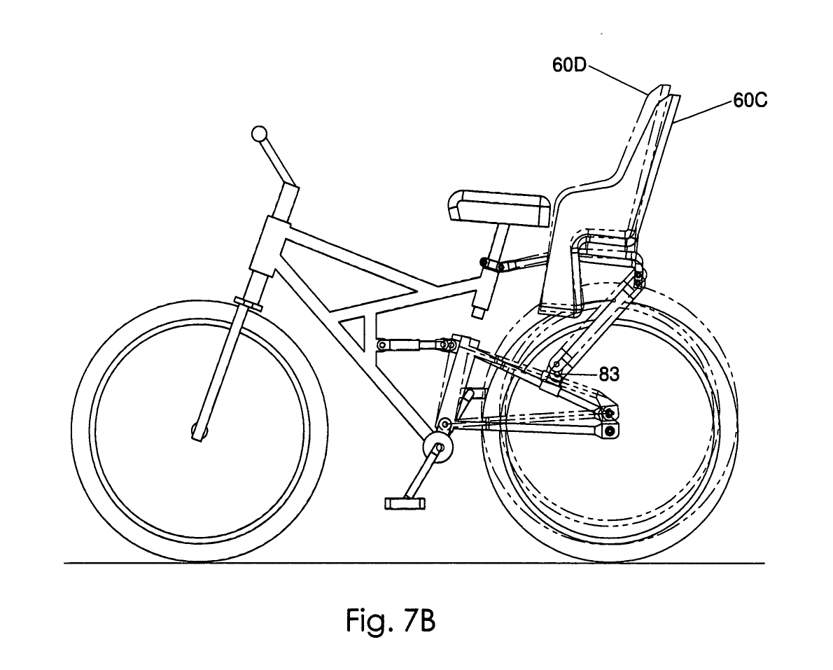

FIG. 7A is an economy type child seat support bracket with rear link pivot mounting provision 82 on the rear bike frame section of a suspension style bicycle. Rear links 84 are connected to this bracket 82, one set on each side of the bike frame of a suspension bicycle, at 83 and link 84 is pivotably connected to tube 25 at the other end. Tubes 25 are secured to the child seat 60. The front of seat support tube 25 is pivotably connected to point 23 on the seat post clamp 12.

FIG. 7B is the child seat bracket design from 7A with an overlay of when the bike suspension is stroked. Child seat position 60D is when the bike is unloaded and seat orientation 60C is from when bike suspension is stroked.

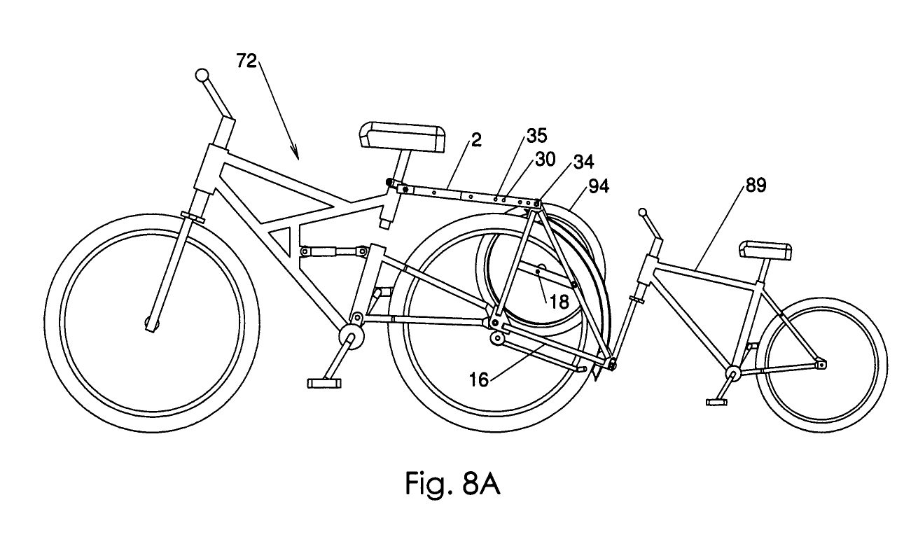

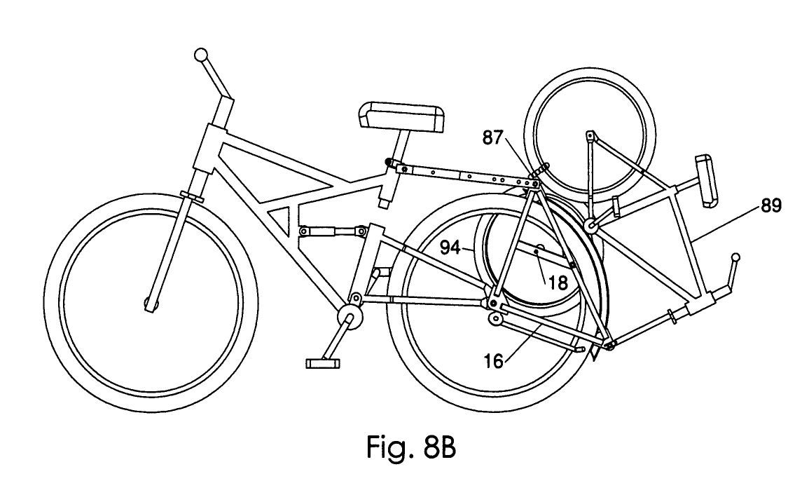

Referring to FIG. 8A, upper links 2 have multiple hole provisions to accommodate different sizes of towed bike 89. For this illustration a 16″ tow bike 89 is installed in a relatively level orientation. This arrangement has upper links 2 attaching to utility bracket 16 through the upper link holes indicated by 34. For 24″ style bikes, mounting hole provision 30 would be used to orient the tow bike hitch point such that the bike will be level when attached. Likewise for 26″ style bikes, hole provision 35 would be used. The towed bicycle's front wheel 94 is secured to utility bracket 16 at hole 18. Other bolt-on accessories such as a luggage rack could be secured in a manner similar to seat 60 to upper links 2.

Referring to FIG. 8B, the 16″ style towed bicycle 89 is flipped 180 degrees about the steer yoke from the orientation shown in FIG. 8A and positioned such that the rear tire rests on the utility bracket 16. The rear tire can be secured to the utility bracket 16 via the chain 87 or bungie cord 88 originally referenced in FIG. 1. The towed or hauled bicycle can easily be returned to the towing configuration from this hauling configuration as desired.

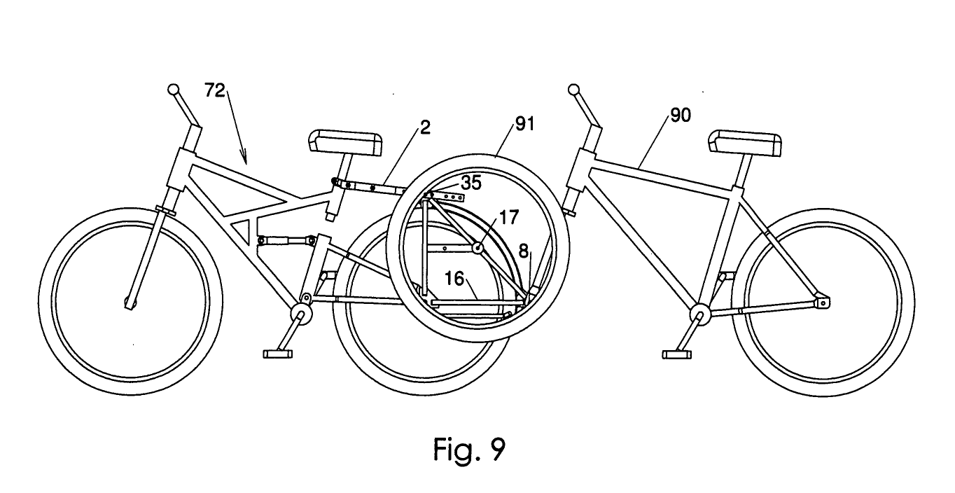

Referring to FIG. 9, a tandem bicycle configuration is shown with two 26″ style bicycles 72 and 90 where the upper links 2 are attached to the tow bike 72 at one end and attached to utility bracket 16 via hole 35 at the other end to accommodate a level towed bicycle mounting. Towed bicycle 90 is connected to bracket 16 at bolt 8. The towed bike front wheel 91 is stored on wheel mounting provision 17 on utility bracket 16.

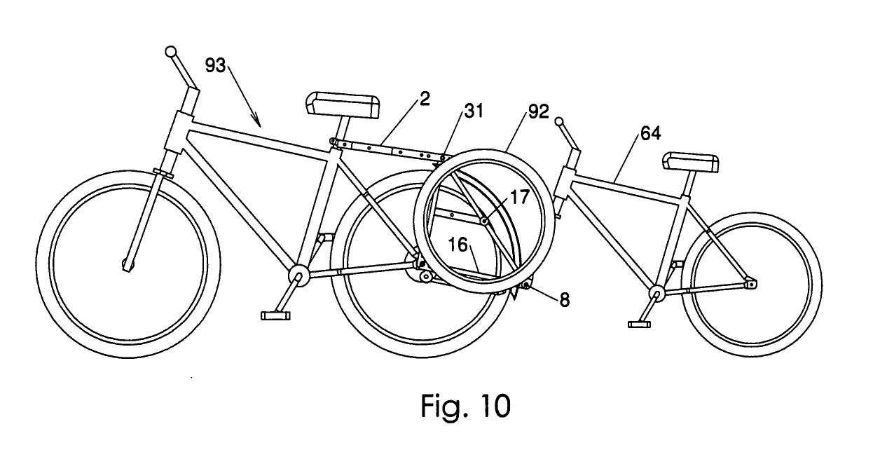

Referring to FIG. 10, a tandem bicycle configuration is shown with a 26″ rigid frame style tow bicycle 93 and a 20″ towed bicycle 64 where the upper links 2 are attached to the tow bicycle 93 at one end and attached to utility bracket 16 via hole 31 at the other end to accommodate a level towed bicycle mounting. Towed bicycle 64 is connected to bracket 16 at bolt 8. The front wheel of the towed bike 92 is stored on wheel mounting provision 17 on utility bracket 16.

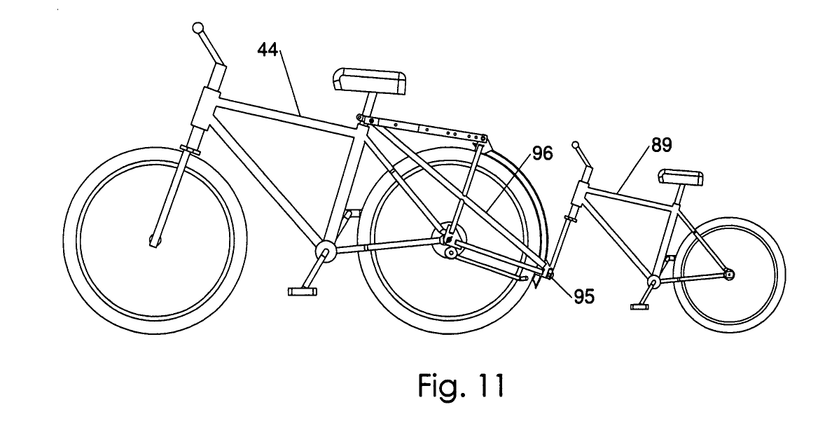

Referring to FIG. 11, a tandem bicycle configuration is shown with a 26″ rigid frame style tow bicycle 44 and a 16″ towed bicycle 89. Towed bicycle 89 is connected to rigid utility bracket 94 at pitch pivot point 95.

The previous description is provided to enable any person skilled in the art to practice the various embodiments described herein. Various modifications to these embodiments will be readily apparent to those skilled in the art, and the generic principles defined herein may be applied to other embodiments such as those listed in the bullets below.
A rear mounted auxiliary child seat support structure device compatible with articulating suspension frame bicycle configurations that includes one or more upper links which is secured to the child seat with one linkage end pivotably attached to the seat post and the other end is pivotably attached to the upper end of one or more lower links that pivotably attach to the rear wheel axle centerline or at some other attachment point secured to the rear frame section of the bicycle.
An auxiliary child seat support structure linkage arranged to dampen vibrational forces applied to the seat by means of the shock absorber on the suspension bicycle frame.
A bicycle utility bracket device that that mounts to a suspension type tow bicycle that simultaneously accommodates an auxiliary child seat and a conventional style towed bicycle.
A bicycle utility bracket device between a tow bicycle and a towed bicycle which includes a provision to store the towed bicycle front wheel in a vertical orientation with the center axle of the stored wheel positioned forward of the towed bike's front wheel axle mounting provision and behind the rear wheel axle of the tow bicycle.
A bicycle utility bracket device that accommodates a tandem tow bicycle and towed bicycle arrangement which uses commonly available, conventional 16″, 20″, 24″ & 26″ bicycles as the towed bicycle with adjustment provisions to keep the towed bicycle relatively level regardless of on the various bicycle sizes.
A tandem bicycle arrangement with a towed bicycle pitch articulation connection to the tow bicycle that is lower than the centerline of the rear axle of the tow bicycle.
A tandem bicycle arrangement accomplished with a bicycle utility bracket mounted between the two bicycles which includes a horizontal articulating pitch connection between the two bicycles that includes a continuous length bolt pivotably secured by wide spaced bushing provisions in the utility bracket where this bolt simultaneously attaches to both the left and right steer yoke bracket ends of the towed bicycle.
A tandem bicycle arrangement accomplished with a bicycle utility bracket mounted between the two bicycles which includes an articulating pitch connection between the two bikes which is lower than the centerline of the rear axle of the tow bicycle and a generally vertical yaw connection between the bicycles which utilizes the existing steering yoke bearing from the towed bike.
A tandem tow and towed bicycle arrangement via a utility bracket between the two bicycles with a fender mounted on the utility bracket assembly in a close, less than 2″, concentrically or nearly concentrically fixed position over the tow bike's rear wheel.
A bicycle utility bracket pivot attachment secured to the rear axle of the tow/main bike which includes a round bracket mounting provision, stand-off length clearance to clear the surrounding components, hexagonal wrench tightening flats and threads to secure the rear wheel axle to the bicycle frame and.
A bicycle utility bracket between two conventional style bicycles that accommodates a tandem bicycle arrangement that can accommodate selectively securing and hauling of the towed bicycle by rotating its frame 180 degrees around the steer yoke and flipping the bicycle up to ride on the utility bracket.
An accessory cargo rack option that can be mounted to a bicycle utility bracket system's upper horizontal connection links.
A flexible linkage and elastomeric tensioning means between the tow and towed bicycles to prevent the towed bike from falling over when the towed bike orientation approaches a relatively perpendicular orientation to the tow bike.
A bicycle utility bracket mounted between two bicycles that accommodates a tandem bicycle arrangement that includes provisions for secure storage for the front wheel of the towed bike in a vertical orientation located behind.
A bicycle utility bracket that accommodates a tandem bicycle arrangement between two conventional style bicycles that includes an auxiliary kick stand attached to the bicycle utility bracket located close to the center line of the tow bike's rear wheel axle.
A bicycle utility bracket that accommodates a tandem bicycle arrangement between a rigid frame tow bicycle and a conventional tow bicycle that includes a horizontal pitch connection provision between the two bicycles that is lower than the center line of the rear axle of the tow bicycle.

Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

I claim:

1. A rear mounted auxiliary child seat support structure device compatible with articulating suspension frame bicycle configurations that comprises: one or more upper links which is secured to a child seat with one linkage end pivotably attached to a seat post and the other end is pivotably attached to an upper end of one or more lower links that pivotably attach to an attachment point secured to a rear frame section of a bicycle.

2. The device according to claim 1, wherein the attachment point is positioned substantially proximate a rear wheel axle's centerline.

3. An auxiliary child seat support structure linkage arranged to dampen vibrational forces applied to a child seat by means of a shock absorber on a suspension bicycle frame.

4. A bicycle utility bracket device configured to mount to a suspension type tow bicycle that simultaneously accommodates an auxiliary child seat and a conventional style towed bicycle.

5. The bracket of claim 4 further comprising: a provision to store the towed bicycle front wheel in a vertical orientation with the center axle of the stored wheel positioned forward of the towed bike's front wheel axle mounting provision and behind the rear wheel axle of the tow bicycle.

6. The bracket of claim 4 further wherein the bracket: accommodates a tandem tow bicycle and towed bicycle arrangement which uses commonly available, conventional 16″, 20″, 24″ & 26″ bicycles as the towed bicycle with adjustment provisions to keep the towed bicycle relatively level regardless of on the various bicycle sizes.
